(19) United States
(12) Patent Application Publication
(10) Pub. No.: US 2008/0102947 A1
(43) Pub. Date: May 1, 2008

(54) Delivery Of Advertising Into Multiple Video Games

(76) Inventors: Katherine Hays, New York, NY (US); David J. Sturman, Port Washington, NY (US); Daniel Melfi, Holbrook, NY (US); J. Richard Skeen, Montclair, NY (US); Claudia I. Batten, New York, NY (US)

Correspondence Address: PERKINS COIE LLP/MSFT, P. O. BOX 1247, SEATTLE, WA, 98111-1247, US

(21) Appl. No.: 10/592,296

(22) PCT Filed: Mar. 8, 2005
(86) PCT No.: PCT/US05/08274

§ 371 Date: Nov. 19, 2007

Related U.S. Application Data
(60) Provisional application No. 60/551,156, filed on Mar. 8, 2004.
(60) Provisional application No. 60/638,637, filed on Dec. 23, 2004.

(51) Int. Cl. A63F 13/00

(52) U.S. Cl. 463/31

(57) ABSTRACT

An advertisement delivery scheme and associated facility provide targeted advertisements for multiple video games without advertisers having to specify specific game titles in which they would like their advertisements placed. The targeted advertisements may be provided via a network connection while the video game applications are executed on gaming devices, or via other means. Advertisements may be targeted to groupings of one or more games, and or groupings of one or more players. Data about the presentation of advertisements, such as impression data, may be collected and reported on, along with other information tracked through a game playing device.

### CROSS-REFERENCE TO RELATED APPLICATIONS

This application claims the benefit of U.S. Provisional Application No. 60/551,156, filed Mar. 8, 2004, and U.S. Provisional Patent Application No. 60/638,637, filed Dec. 23, 2004, both of which are herein incorporated in their entirety by reference.

### BACKGROUND

Advertising in video games is becoming increasingly popular with both advertisers (who wish to target specific markets through the use of particular game titles) and game developers (who view advertising as a huge revenue opportunity to counterbalance the increasing development costs that result from the demands of today's market). For example, game players are typically more engaged than watchers of television and consumers of other media, resulting in a greater likelihood that advertisements in video games will be observed. In addition, the amount of time people spend playing video games is increasing, while the amount of time people spend watching television and using other traditional media (e.g., print, radio, etc.) is decreasing.

Various techniques have been described to display advertisements in video games. For example, video game developers/publishers may place advertisement-related images within the scenery of their games (e.g., billboards, stadium signs, etc.). In many cases, these advertisements are built in to the game code (e.g., hard coded) and displayed consistently (e.g., at the same place/time) in the game. Based on this hard coding, they can not be changed. In other cases, the advertisements may be provided to the game through a network connection so that the advertisements can be provided for display in the game after the game code has been developed, thus allowing for more dynamic advertisement content.

While such advertising opportunities potentially offer an amazing landscape for advertisers to work with, current techniques for providing advertisers with opportunities for advertising in games are quite limited and are often difficult to implement, and do not meet the needs of advertisers (especially large advertisers) in the way they buy and use mediums for advertising. For example, advertisers who desire to advertise in video games have typically been limited to advertisement opportunities in individual games by working directly with a video game publisher. This approach is subject to many constraints for advertisers including: limited reach—as there is no way to aggregate the audience across game titles to deliver large audiences or “quick reach” over a short time frame—e.g., during a single night, or week; inflexible timing—as there is no ability to start and stop campaigns with precision which has kept categories and ad budgets out of video games as an advertising medium, e.g., movies (spend up to $1.5 billion to reach 18-34 million annually); and a lack of measurement and control—video games are a “hit”-driven business. Therefore, advertisers have been constrained by a lack of certainty around audience reach and timing and have had no way to measure campaign effectiveness, imposing a reliance on the market performance of the individual video game, which may not sell according to publisher forecasts and which also is typically prone to delay. In a reverse scenario, advertisers are often blocked out of opportunities to advertise in a run-away hit.

Likewise, for game publishers/developers, implementing an effective advertisement campaign typically involves extensively working with advertisers to profile game players, select appropriate game titles for target advertising, manage advertisement delivery, report back to advertisers, etc. In addition, current techniques (e.g., hard-coding and network delivered advertisements) are typically inflexible and force yet another demand on game developers' schedules. Also, developing an advertisement sales department is costly for game developers/publishers and typically depends on extensive management.

### BRIEF DESCRIPTIONS OF THE DRAWINGS

FIG. 1A is an example of a suitable environment in which the advertisement delivery scheme and associated facility can be implemented.

FIGS. 1B and 1C are display diagrams showing example screen shots associated with various user/administrative interfaces of the example suitable environment of FIG. 1A.

FIGS. 2-4 are examples of the flow of data through various components of the example suitable environment of FIG. 1A.

FIG. 5 is an example of a general computing environment in which aspects of the advertisement delivery scheme and associated facility can be implemented.

FIG. 6 is a display diagram showing a sample insertion order for selling advertisements space in association with the advertisement delivery scheme and associated facility.

FIG. 7 is a flow diagram showing an example of a routine used in impression counting.

FIG. 8 is a display diagram showing an example of a report generated by the advertisement delivery scheme and associated facility.

Note: the headings provided herein are for convenience and do not necessarily affect the scope or interpretation of the invention.

A portion of this disclosure contains material to which a claim for copyright is made. The copyright owner has no objection to the facsimile reproduction by anyone of the patent document or patent disclosure (including the Figures) as it appears in the Patent and Trademark Office patent file or records, but the copyright owner reserves all other copyright rights whatsoever.

### DETAILED DESCRIPTION

The invention will now be described with respect to various embodiments. The following description provides specific details for a thorough understanding of, and enabling description for, these embodiments of the invention. However, one skilled in the art will understand that the invention may be practiced without these details. In other instances, well-known structures and functions have not been shown or described in detail to avoid unnecessarily obscuring the description of the embodiments of the invention.

The terminology used in the description presented below is intended to be interpreted in its broadest reasonable manner, even though it is being used in conjunction with a detailed description of certain specific embodiments of the invention. Certain terms may even be emphasized below; however, any terminology intended to be interpreted in any restricted manner will be overtly and specifically defined as such in this Detailed Description section.

### I. Overview

In the past, advertisers who wished to advertise in video games were limited to selecting specific individual game titles for presenting their advertisements. An advertisement delivery scheme and associated computerized facility allow advertisers to deliver their campaign messages to specific audiences they wish to target across one or multiple game titles played across multiple platforms (e.g., PC, console, mobile, etc.) without being limited to delivering their campaign to only a single specific game title. In some embodiments, the advertisement delivery scheme aggregates an audience across multiple video games and platforms (PC, console, mobile, etc.) and can deliver advertisements to that audience by advertiser request. Consequently, advertisers are able to go to one place to substantially simultaneously reach a narrowly targeted audience, a widely targeted audience, or both across numerous game titles and can broadcast advertising to this audience based on ad campaign needs (e.g., reach 1 million men ages 18-34 at 8 p.m. on Thursdays).

In accordance with some embodiments, the advertisement delivery scheme and associated facility present advertisements as texture maps or other graphical displays (e.g., animations, video, etc.) on pre-designated geometry within the game, such as billboards, storefront signs, panel trucks, Jumbotron screens in a sports stadium, posters on walls, T-shirts on a game character, items used by game characters (e.g., a brand name soft drink or energy bar), and so on. Each of these spaces may be termed an “available ad unit” or “inventory element.” Available ad units may also be available at the beginning of a game, at the end of a game, in between levels (e.g., as commercial-like intermissions), as parts of menus, on a “pause” screen, etc. Available ad units may include audio characteristics as well as visual characteristics. Other characteristics for available ad units are also possible (e.g., scented elements, image projections into three-dimensional space, actual structures within the game, such as a car).

When a game is shipped, it may have a fixed set of available ad units grouped into zones (typically delineated by game levels or areas of play). However, other available ad unit configurations may be possible. Some available ad units may be interactive within the game (e.g., a game character eating a brand name energy bar to boost her power in the game, a brand-related “mini game” presented between levels, a click-through advertisement, etc.) and may bring aspects of the real world into the game (e.g., a player can enter a code from a product to provide advantages in the game).

An example of a representative environment that may be used to implement the advertisement delivery scheme and associated facility may include an advertisement server with various components and services, including client library functions that provide an easy way to link game code (including previously developed game code) with the advertisement server. The advertisement server may also include one or more database components that contain data regarding game inventories, media files, impression statistics, reporting, etc.

When a game is played at a player's gaming device (e.g., computer or game console) that is connected to an advertisement server (e.g., via the Internet or another connection), the client library functions associated with the game application may pull media data from the advertisement server and pass them on to the game code, so that specific advertisements may be presented in the appropriate available ad units at the appropriate time during game play. Communication between the advertisement server and the gaming device may be done sporadically, periodically, or by maintaining a constant connection between the appropriate components while the game is being played.

In some embodiments, components of the advertisement server may be used to track and manage large sets of available ad units from multiple game titles, forming a network of available advertisement spaces. Based on information associated with each of the available ad units (e.g., current game environment, game title genre, predicted player demographic information for current available ad unit, player geography, time of day, etc.), the advertisement server may then (through matching and optimization) distribute and deliver targeted advertisements to players' gaming devices, where the advertisements may be integrated into the relevant game areas in real time. For example, the multiple games that comprise the network of available advertisement spaces can be divided by genre such as sports titles (and even further by specific sport), children's titles, racing titles, etc. Accordingly, advertisers can target the delivery of their advertisement campaign specifically to a sub-channel as that sub-channel relates to their campaign. Accordingly, advertisers can target the delivery of their advertisement campaign specifically to a sub-channel as that sub-channel relates to their campaign or may subtarget by time of day (e.g., deliver advertising to all gaming devices playing at 8 p.m. on Thursday) or by game play date (e.g., once the game has been played for 45 minutes—air the Domino's ad campaign, or in the fourth inning of the sports title, air the XYC campaign). This targeting may include the game devices of game players involved in multiplayer games (who may all see the same advertisement simultaneously).

Both advertisers and game developers/game publishers can benefit from various aspects of the advertisement delivery scheme and associated facility. For example, from the advertisers' perspective, for the first time, advertisers may reach a gaming audience in aggregate—enabling them to reach large audience or “quick reach” over a short time frame. For example, through the advertisement delivery scheme, advertisers can reach millions of game players in a single night. In the past, this was not possible and an advertiser would be limited to the number of players it could reach in a short time frame. Advertisers can also take advantage of the dynamic nature of the advertisement delivery scheme to run time-based advertisement campaigns based on seasons, specific days (e.g., only on Sundays), specific dates (e.g., the day before Valentine's Day), specific times of day (between 6 and 9 p.m.), or events (e.g., scheduled multiplayer game tournaments, movie releases, etc.) not known before the game release. In addition, the dynamic nature of aspects of the advertisement delivery scheme allows a great deal of flexibility for advertisers, who no longer face the risky task of selecting specific game titles in which to display their advertisements. The advertisement delivery scheme may also target the delivery of an advertisement to a specific demographic regardless of the video game being played. For example, most video games have a relatively low female audience, which discourages advertisers wishing to target females from advertising in video games. The advertisement delivery scheme enables this audience to be aggregated and targeted as a specific audience and creates a viable critical mass of viewers for advertisers, thus opening up previously untapped minority demographics. In general, the advertisement delivery scheme enables an advertiser to deliver advertising across a range of electronic mediums including consoles (such as Sony Play Station and Microsoft Xbox), PC and Macintosh computers, wireless equipment (cellular phones and other wireless gaming devices) and ultimately electronic billboards and televisions.

From the game developers'/game publishers' perspective, game developers/game publishers no longer need to be extensively involved with implementing and managing advertisements in their games. In addition, because advertisers are no longer focused on selecting advertisement placement using game titles, even developers of smaller or lesser-known games (that may otherwise be denied advertising dollars) are provided with the opportunity include advertisements in their games. Also, the advertisement delivery scheme may ensure that “reach” commitments made to advertisers can be more easily satisfied and verified. Further more, due to the viable critical mass of viewers and the ability to “quick” reach across large audiences, the advertisement delivery scheme unlocks significantly larger advertising budgets than larger advertising budgets. Of course, many other benefits to both advertisers and game developers exist.

The advertisement delivery scheme and associated facility may also include components and services that track and audit the quality of presentation of the in-game advertisements. For example, components and services of the advertisement delivery scheme and associated facility may track, audit, and report on advertisement impressions (which quantify the presentation qualities—e.g., viewing angle, percent screen size, time on screen, etc.—of an advertisement as presented in any given instance). This collected information (and other information collected by the advertisement server) may then be used in billing to ensure that advertisers pay only for advertisement presentations that meet specified thresholds. The collected information may also be provided and/or sold to advertisers (and possibly developers and other parties) to guide future planning decisions.

In addition to advertisements, other types of information may be delivered to games using the advertisement server, thereby enhancing the experience of the game player. For example, it may be possible to provide real-time content in a game, such as NFL scores, weather information, holiday decorations in cityscapes, etc.

### II. Representative Environments

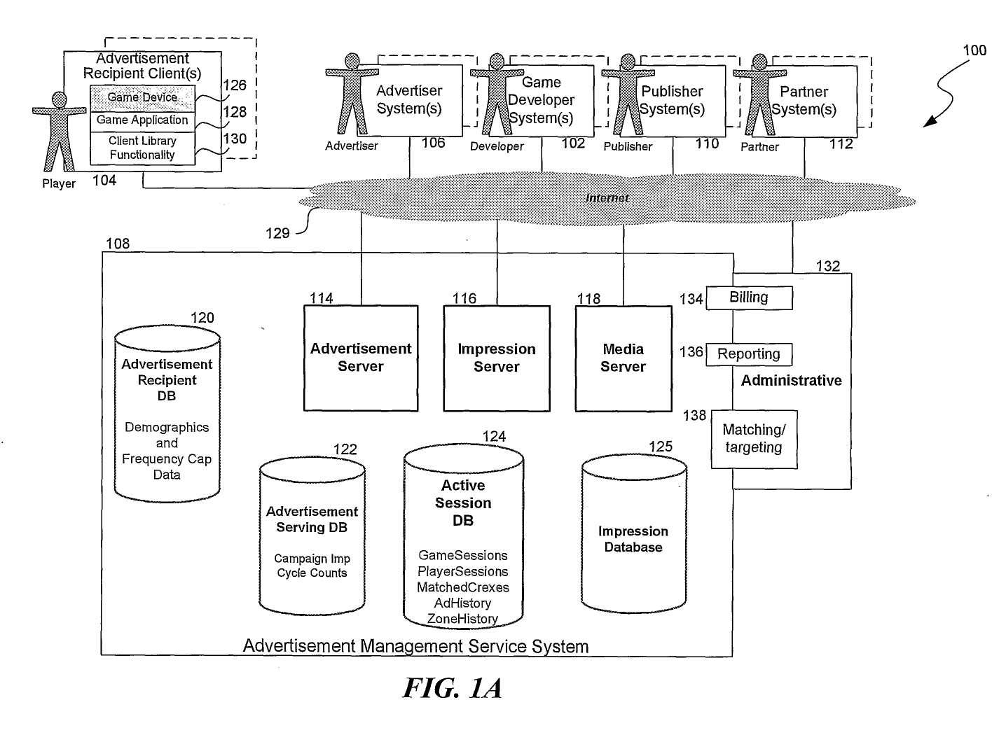

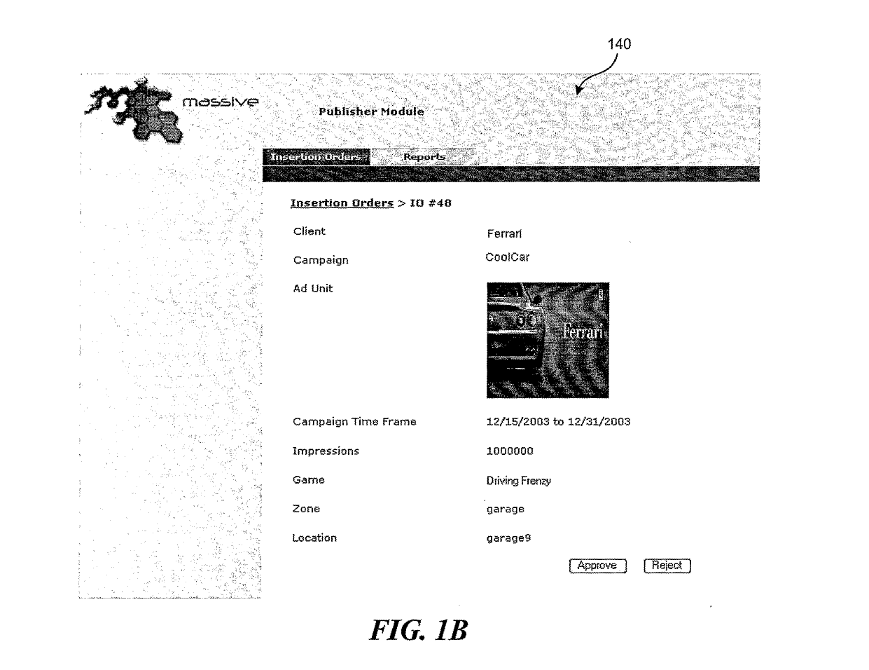

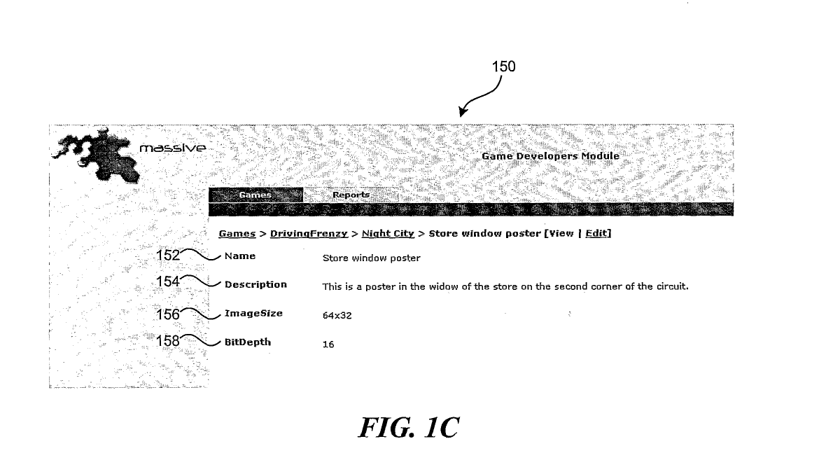

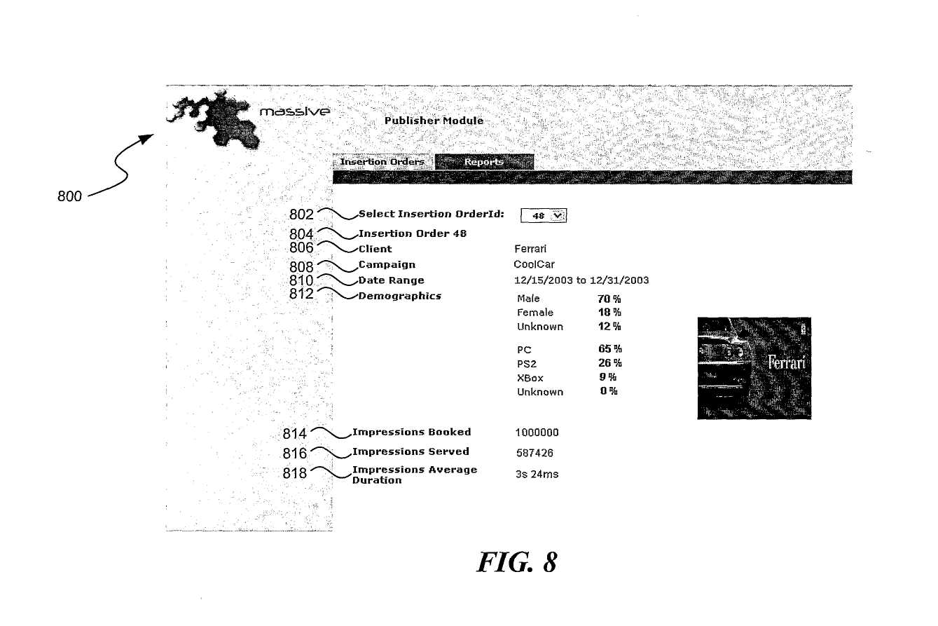

Referring to FIG. 1A, a suitable environment 100 in which aspects of the invention may operate includes several interconnected systems, each corresponding to various entity groups including at least one game developer system 102, at least one advertisement recipient client 104 (e.g., game player system), at least one advertiser system 106, at least one advertisement management service system 108, and at least one game publisher system 110 that publishes a game title and holds final approval in the content of the game. In general, advertisers, game publishers, and game developers may work with the advertisement management service to manage the dissemination of advertisements. For example, the publisher system 110 may link with various interfaces of the advertisement management service system 108 that allow the publisher to approve or reject insertion orders, as shown in FIG. 1B, and to view associated reports (described in more detail with respect to FIG. 8). Other systems may also be included, such as at least one partner system 112 that provides real time content (e.g., weather reports, sports scores, news headlines, etc.) or other information that may be delivered real-time into games.

The advertisement management service system 108 may include various components and services that facilitate the management and dissemination of advertisements into games. In some embodiments, the advertisement management service system 108 includes an advertisement server 114, an impression server 116, and a media server 118 (which stores and serves specific media files containing advertisement display/audio information—e.g., image files, audio files, video files, executables, etc.—to the advertisement recipient client 104 upon request). In addition to the various servers, the advertisement management service system 108 may include various databases, including an advertisement recipient database 120, an advertisement serving database 122, an active session database 124, and an impression database 125. The advertisement management service system may also include an administrative component 132, with interfaces and access to billing 134, reporting 136, matching and targeting administrative access 138, and general system maintenance.

In some embodiments, the advertisement server 114 may fulfill requests received from the advertisement recipient client 104 for advertisements and associated media, including supporting advertisement requests from the advertisement recipient client 104. This may include handling initial connections, providing requested lists of advertisements for specific available ad units, serving media, etc.

In general, the advertisement server 114 may select advertisements based upon a variety of factors, including location, time of day, game player demographics, game play data, etc. The advertisement server 114 may use information retrieved from the advertisement serving database 122, such as “flight” information that describes the time frame in which any particular advertisement or advertisement campaign is set to be presented in games played during that time frame. For example, an advertisement campaign may include one or more advertisements, along with related targeting or presentation parameters specified for flight during a specified date range. Advertisement campaigns may be grouped for logical structure and aggregate reporting. The advertisement server 114 may also retrieve records from the advertisement recipient database 120 (e.g., demographic and login information for specific players) to select appropriate advertisements to serve to current available ad units that the game player will see in the video game. Game player demographic information may be extracted from the advertisement recipient database 120 upon starting a gaming session. Game play data may also be relayed to the advertisement server 114 and may be used to determine ad delivery (e.g. a Domino's campaign that runs once garners have played a single game session for over 45 minutes—research has shown that this leads to more pizza purchases). This process facilitates selection of the advertisements that the game player will see. In some embodiments, the publisher system 110 may request specific demographic information from the advertisement recipient database 120, including information specific to their game products/titles.

In some embodiments, the impression server 116 of the advertisement management service system 108 may record impression information related auditing information and other reporting data (e.g., ads or text viewed but not counted as an impression) and gaming data (e.g., average game session in minutes, number of live game sessions by day-part, geography, etc.). The impression server 116 may then write this information to the impression database 125. The impression server 116 may also update information about impression counts for specific flights within the advertisement serving database 122.

The advertisement recipient client 104 may include a game playing device 126 (e.g., a console, computer, portable game device, etc.) on which a game application 128 executes. The game playing device 126 may request and receive advertisements from the advertisement management service system 108 and may be configured to establish communication via a communication link, such as the Internet 129. To facilitate communication with the advertisement management service system 108, the game application may include integrated functionality associated with a client library 130 that handles connections and data exchange with the publisher system 110. In some embodiments, the client library functionality 130 is initially incorporated into the game application via exchanges of information between the game developer system and the advertisement management service system 108. During this process, the game developer may specify memory management and file access parameters for use by the client library functionality 130. Accordingly, in terms of memory and processing resources, the functionality associated with the client library functionality 130 may maintain a low profile in the game playing device 126.

For “offline play” the advertisement recipient client 104 is not constantly communicating with the advertisement management service system 108. In such a scenario, the advertisement recipient client 104 connects to the advertisement management service system 108, starts a session, requests and retrieves flights and media, and caches this information locally. As the game is played, the advertisement recipient client 104 may record and cache view and impression information. Later, when the advertisement recipient client 104 reconnects to the advertisement management service system 108, it contacts the impression server 116, flushes all cached view and impression data, and then ends the session.

With an offline play scenario, advertisements may be downloaded “in the background” during times when the advertisement recipient client 104 is connected to the advertisement management service system 108, including when the gaming device is performing other tasks, such as executing a different game, operating a web browser, etc. Various applications that run quietly on the advertisement recipient client 104 may be responsible for downloading the advertisements during such times without requiring active user involvement. In another scenario, player incentives for actively downloading advertisements during non-play time may also be provided. For example, a player may accept to actively download advertisements in exchange for receiving a desirable upgrade to the game (e.g. a new weapon, game hints, new game levels, new game characters, etc.). Alternatively, the advertisement management service system 108 may provide advertisement data by alternative means/media, such as CD-ROM, cable connections, satellite, telephone line, etc.

In some embodiments, the game developer system 102 and the advertisement management service system 108 may communicate to incorporate at least a portion of the client library functionality 130 into a game title, which may include having the developer specify the availability of available ad units within specific game titles.

For example, as shown in the example “developer view” screen shot of FIG. 1C, the specific information may include an inventory element/available ad unit name 152, a short description 154, a screen shot showing the inventory element/available ad unit as it appears in the game (not shown), information about the genre of the game title (not shown), the descriptive information about the specific game level , zone, or scene in which the inventory element/available ad unit exists (not shown), known or predicted demographic information about the players of the game (not shown), etc. The specific information may also include information about technical features (e.g., size 156, shape (not shown), media type (not shown), bit depth 158, etc.) of such inventory elements/available ad units.

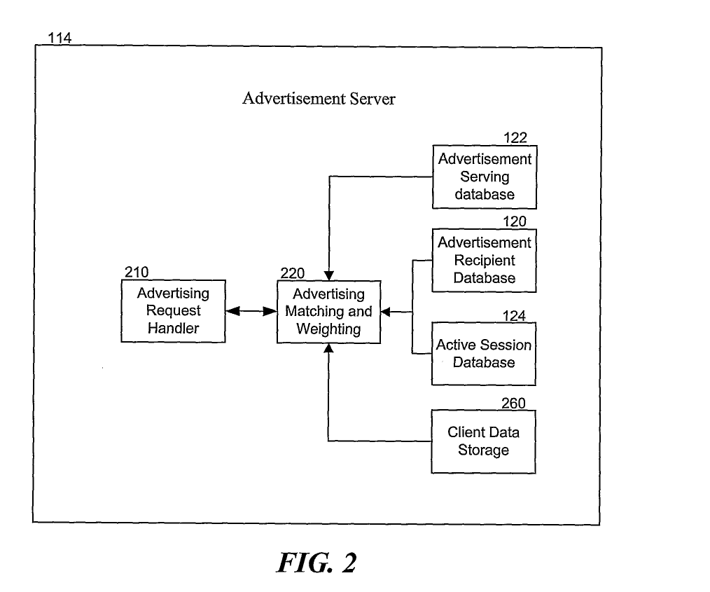

Referring to FIG. 2, various flows of data may occur in association with the advertisement server 114 delivering advertising to one or more advertisement recipient systems, such as the advertisement recipient client 104 of FIG. 1A. For example, an advertisement recipient client (not shown in FIG. 2) may communicate with an advertising request handler 210 associated with the advertisement server 114. This may enable the matching of advertisement campaigns to appropriate various video game titles.

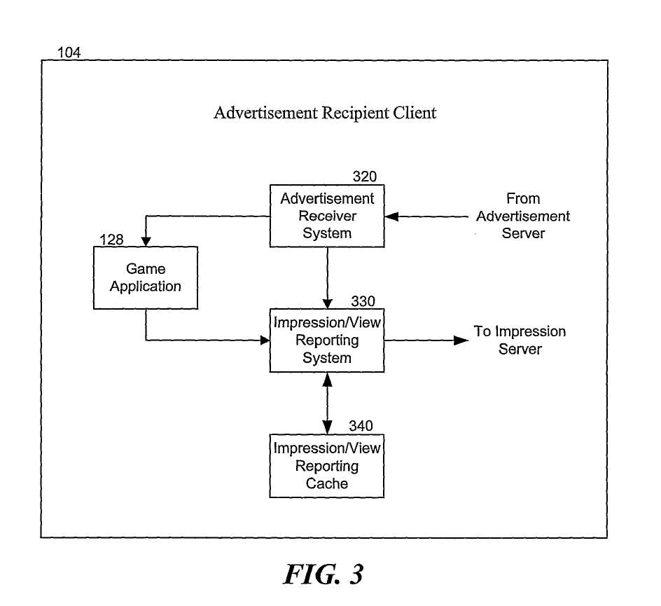

In some embodiments, the advertisement recipient client 104 begins by establishing or joining a session with the advertisement server 114. Establishing this session may create a record in the active session database 124, which registers the game player as the first member of the new session and is used to track and record all communications and data sent to and received from the advertisement recipient client 104. In response to establishing this session, the advertisement server may 114 may assign the advertisement recipient client a session ID, which the advertisement recipient client 104 may use for all communications with the advertising server 114 and an impression server, such as the impression server 116 of FIG. 1A, which is described in more detail with respect to FIG. 3.

If the advertisement recipient client 104 is joining an existing session, the advertisement server 114 may not generate a new record in the active session database 124. However it may record the joining game player as a member of the session, provided the session exists and is active in the active session database 124. When a game player specifically and actively leaves a session, the advertisement recipient client sends a message indicating the game player left, or when a specified time of inactivity passes between the advertisement recipient client and the advertisement server 114 passing messages, that game player is removed as a member of the game player's current session. When the session has no game players as members that session is ended and marked as inactive in the active session database 124.

In some embodiments, the advertisement recipient client 104 requests advertisements for delivery to one or more available ad units within the client software application. This request contains a data structure that includes a unique identifier to indicate the client type, another unique identifier for the specific game player, the session ID and the list of advertising units for which advertisements are being requested. The client type can effectively be a SKU, which includes a type of game console, game, language, etc. (Alternatively, the data structure may be locally stored data, similar to a cookie.) The advertising request handler 210 forwards this request to an advertising matching and weighting system 220. The advertising matching and weighting system 220 processes the request and produces a set of one or more matched advertisements to be displayed for each available ad unit, specified within the client's request.

In some embodiments, the advertisement serving database 122 contains advertising information that is available to potentially display on all advertisement recipient clients within the framework of the advertising delivery scheme and associated facility. A set of advertising for each request may be extracted from the advertisement serving database 122 based on data retrieved from a advertisement recipient database 120 keyed upon the unique client identifier. In some embodiments, the tail end of this process (e.g., actually delivering the files and data that the advertisement recipient client 104 uses to display the advertisement) may be handled by a media server that functions as an edge server, such as the media server 118 of FIG. 1A. In effect, the delivery of the content for advertisements may be separated from the metadata concerning the advertisement.

The advertisement recipient database 122 contains information about the technical media formats accepted by each advertising destination within an advertisement recipient client and about which advertising has been specifically approved for each advertisement recipient client by a game publisher/developer. Only advertisements that can provide the correct media format for the requested destination and that have been specifically approved to be displayed within the client may be included in the set of advertising.

The advertisements retrieved from the advertisement serving database 122 by the advertising matching and weighting system 220 are assigned a weight by the advertising matching and weighting system 220. The advertising matching and weighting system 220 may calculate the weight of each advertisement based on several factors including campaign goal and completion data from the advertisement serving database 122 and information regarding the specific client type from the advertisement recipient database 120. The advertising matching and weighting system 220 then selects one or more advertisements from the weighted advertisement set, where the probability of an advertisement being selected is directly derived from the advertisement's assigned weight, relative to other advertisements in the set. The selected advertisements are then sent back to the requesting advertising request handler 210 and transmitted back to the advertisement recipient client for display.

Optionally, advertising can be further targeted based on specific demographic characteristics of a game player. This targeting is specified within the advertisement serving database 122 and used to compare against data retrieved from a client data storage 260 by the advertising matching and weighting system 220. The client data storage 260 contains demographic information regarding a specific game player. This information may be collected from various sources, both internal and external to the advertisement management service system 108. For example, it may contain demographic information about a game player collected via the use of an IP address, including information tracked by the advertisement management service system 108 and/or information purchased or traded from other data collection sources (e.g., Internet service providers, data mining companies, online retailers, etc.). Aside from general demographics (e.g., age, sex, geographic location, hardware software platforms, etc.) examples of such data include data about purchasing habits of a game player, information about web sites that the game player visits, information about purchasing habits of the game player, information, etc.

The data in the active session database 124 records the advertisements that have been delivered to a session, and may serve multiple purposes. For example, the advertising matching and weighting system 220 may use this data along with impression data, also stored in the active session database 124, to allow frequency caps (e.g. a limit as to a number of times a particular advertisement is displayed in a single game session or level/location in the game). Frequency caps may prevent a gamer from being presented with advertisements from the same campaign in excess of a number of times specified within the campaign data. The active session database 124 data may also be used to support multiplayer sessions, etc.

In modern software, which supports multi-user sessions, it is common to attempt to generate a “shared space” as game players can communicate about the space by voice or other form of chat. A “shared space” means that all game players within the session perceive identical environments with identical artistic elements at the same perceived location. To enable this, an advertising matching and weighting system 220 associated with the advertisement server 114 may use the active session database 124 both to record the advertisements delivered to the advertisement recipient client within a session to first request an advertisement for a specific location, and to ensure that all subsequent session-specific advertisement recipient client requests for advertisements for that specific location are fulfilled with the same advertisement, as recorded in the active session database 124.

Referring to FIG. 3, various flows of data may occur in association with an advertisement recipient client 104 of FIG. 1A receiving advertising. In some embodiments, the advertisement recipient client 104 presents the advertisement media it receives from the advertisement server 114 to the game player via an advertisement receiver system 320. Via tools provided by client library functionality (such as the client library functionality 130 of FIG. 1A), the game application 128 calculates various metrics regarding the presentation. These metrics may vary based on the type of media being presented (image, video, audio, 3D object, etc.). The metrics may be reported by the game application 126 to an impression/view reporting system 330 associated with the advertisement management service system (e.g., via the client library functionality 130 of FIG. 1A).

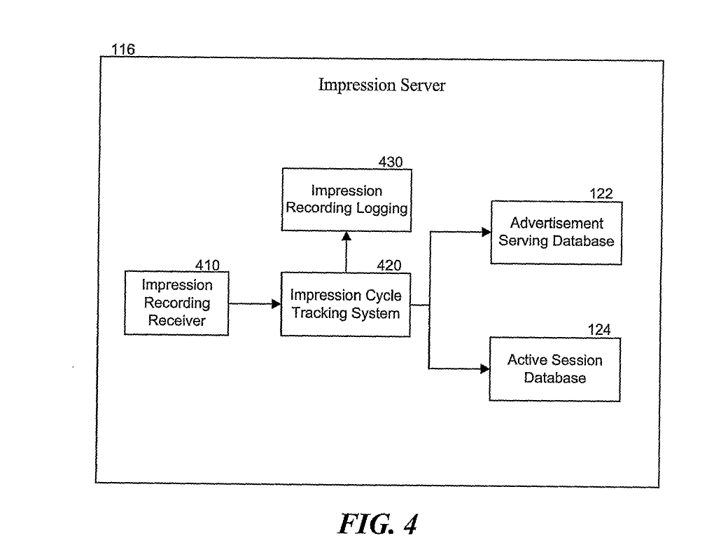

In some embodiments, the impression/view reporting system 330 may compare the reported metrics against minimum presentation threshold values for each advertisement received by the advertisement receiver system 320 from the advertisement server 114 and determine whether the presentation of the advertisement to the user met or exceeded the specified threshold values for the specific advertisement. If the report indicates such thresholds were met, the impression/view reporting system 330 may record that an impression was made. If the report shows a failure to meet the thresholds, only a “view” is recorded. Metrics may be accounted for frequently and periodically (at least once every half second). The metrics may then be aggregated with their average values and impression or view statuses and are recorded into an impression/view reporting cache 340. This aggregation and caching reduce the bandwidth necessary for reporting these values to the server, as only periodic updates containing this aggregated data (at least once every two minutes) are transmitted to the impression server 116 of FIG. 1A, as is described in more detail with respect to FIG. 4.

Referring to FIG. 4, an impression recording receiver 410 associated with the impression server 116 receives the data sent by the advertisement recipient client 104, as described in FIG. 3. In some embodiments, the impression server 116 may use impression cycles (rather than individual impressions) for recording the effectiveness of presentation and impression exposure. For example, an impression cycle may be a single game player's cumulative timed exposure to one or more advertisements contained within a single advertisement campaign. To be counted as a complete impression cycle, the advertisement recipient client reports an impression of the advertisement media for a cumulative minimum amount of time. This exposure may occur in a single instance or may be broken up as the various advertisement media for the advertisement campaign is reported in different states (impression, view, and out of view) and transitions between these states.

An impression cycle tracking system 420 may receive the reports from the impression recording receiver 410, record raw reported data to an impression recording logging system 430, and maintain a list of all partially complete impression cycles for each campaign, for each individual game player. This list may contain cumulative exposure times and may be updated, as appropriate, based on the data reported by advertisement recipient clients. When the cumulative exposure time for a campaign exceeds a set threshold stored within the advertisement serving database 122, the impression cycle tracking system 420 may update the data in the advertisement serving database 122 to mark the completion of an impression cycle for the relevant campaign.

### Suitable Computer Systems

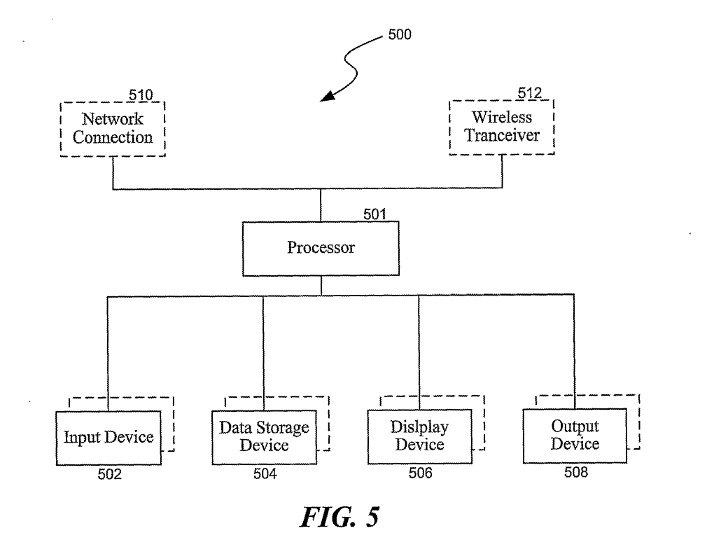

Aspects of the invention employ one or more game consoles or computing devices. FIG. 5 and the following discussion provide a brief, general description of a suitable game console or computing environment in which aspects of the invention can be implemented. Although not required, aspects and embodiments of the invention will be described in the general context of computer-executable instructions, such as routines executed by a general-purpose computer, e.g., a server, game console or personal computer. Those skilled in the relevant art will appreciate that the invention can be practiced with other system configurations, including Internet appliances, hand-held devices, wearable computers, cellular or mobile phones, multiprocessor systems, microprocessor-based or programmable consumer electronics, set-top boxes, network PCs, mini-computers, mainframe computers, and the like. The invention can be embodied in a special purpose computer or data processor that is specifically programmed, configured or constructed to perform one or more of the computer-executable instructions explained in detail below. Indeed, the term “computer,” “game console,” “console,” or the like, as used generally herein, refers to any of the above devices, as well as to any data processor.

The invention can also be practiced in distributed environments, where tasks or modules are performed by remote processing devices, which are linked through a communications network, such as a Local Area Network (“LAN”), Wide Area Network (“WAN”) or the Internet. In a distributed environment, program or game modules or sub-routines may be located in both local and remote memory storage devices. Aspects of the invention described below may be stored or distributed on computer-readable media, including magnetic and optically readable and removable computer discs, and stored as firmware in chips (e.g., EEPROM chips), as well as distributed electronically over the Internet or over other networks (including wireless networks). Those skilled in the relevant art will recognize that portions of the invention may reside on a server computer, while corresponding portions reside on a client computer. Data structures and transmission of data particular to aspects of the invention are also encompassed within the scope of the invention.

Referring to FIG. 5, one embodiment of the invention employs a console or computer 500 having one or more processors 501 coupled to one or more user input devices 502 and data storage devices 504. The console is also coupled to at least one output device such as a display device 506 (e.g., a TV) and one or more optional additional output devices 508 (e.g., speakers, tactile or olfactory output devices, printer, etc.). The console may be coupled to external consoles or computers, such as via an optional network connection 510, a wireless transceiver 512, or both.

The input devices 502 may include a game pad, keyboard and/or a pointing device such as a mouse. Other input devices are possible such as a bar code reader/scanner, magnetic card swipe reader, check reader, fingerprint reader, microphone, joystick, pen, scanner, digital camera, video camera, and the like.

The data storage devices 504 may include any type of computer-readable media that can store data accessible by the console 500, such as cartridges with semiconductor memory, magnetic hard and floppy disk drives, optical disk drives, magnetic cassettes, tape drives, flash memory cards, digital video disks (DVDs), Bernoulli cartridges, RAMs, ROMs, smart cards, etc. Indeed, any medium for storing or transmitting computer-readable instructions and data may be employed, including a connection port to or node on a network such as a local area network (LAN), wide area network (WAN) or the Internet (not shown in FIG. 5).

### III. Network Overlay Schemes

In some embodiments, advertisement campaigns are simultaneously delivered in real time into multiple game titles—this allows the advertisement management service to aggregate the audience across multiple titles and publishers and is a platform agnostic solution. An advertiser may buy advertisement opportunities based on time of day, day of week, etc.—and then have its campaign “broadcast” across all the games being currently played in connection with the advertisement management service. For example, Dominoes pizza may run an advertisement campaign that runs every night at 8 p.m. in all game titles that are being played at that time. The Dominoes campaign may, however, appear differently in each game (e.g., a billboard in a racing game, a storefront in a cityscape game, a pizza box in a first person-shooter title, etc.). When the advertisement management service receives an insertion order from an advertiser, the advertisement is adapted for each of the titles that will be live in the network during the time period the campaign will run. Some back-end matching logic is set at that point, which is one way to improve the efficiency of the system.

### A. Targeting and Insertion Orders

In some embodiments, advertisers use insertion orders to contract with the advertisement management service to place advertisements within a game, a game zone, or specific available ad unit for a defined period of time and view frequency. For example, a company may request its logo to be placed on any panel trucks in Zone 7 of the game “Driving Frenzy” (a fictional game) for the next three weeks but no more than three times per game session for a total of 1 million impressions.

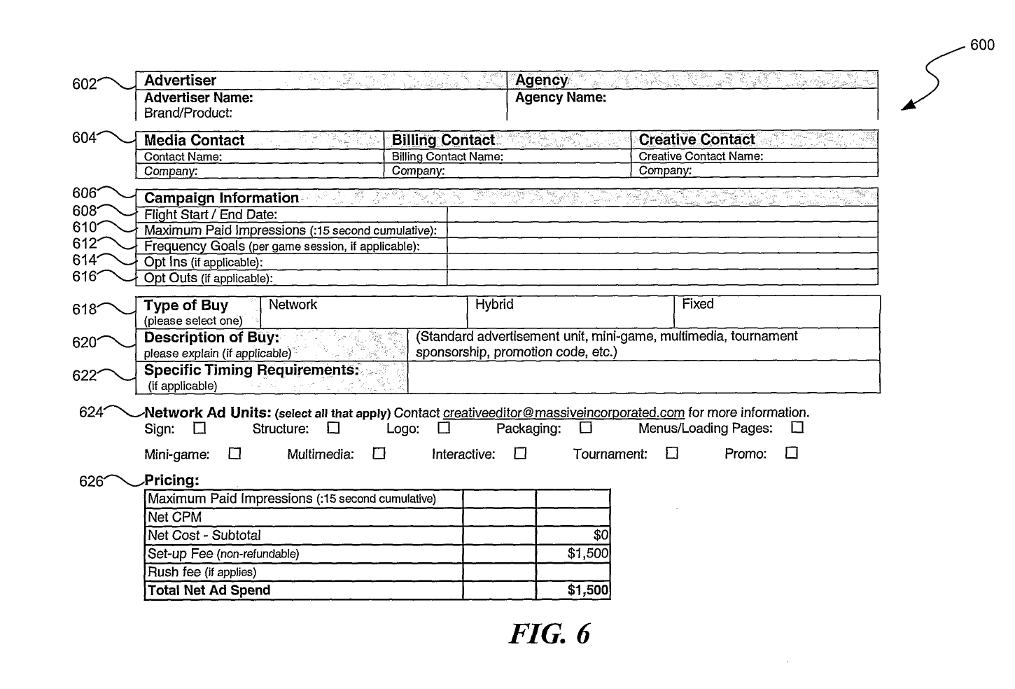

The insertion order is then entered onto the advertisement serving database, for example, via a Web interface. Game publishers then can review/approve the insertion order (e.g., online) before the insertion can run in the game. FIG. 6 shows an example of such an insertion order 600. The insertion order 600 may include advertiser/agency information 602, media and billing contact information 604, and campaign information 606, which includes flight start/end date 608, maximum paid impressions 610, frequency goals per game session 612, targeting opt ins 614, targeting opt outs 616, etc. For example, an advertiser buying a flight in June may look at a list of the likely line-up of game titles available through the advertising management service system. The advertiser could, for example, make exclusions for all titles with a “Mature” rating, or may opt in to only be in titles that are sports genre, or only to run in a specific geography. Or Pepsi may pay a premium to be the exclusive soft drink advertiser for a period of time. This would mean that a Coke advertisement could never run in the same game session as a Pepsi advertisement. In some cases, advertisers may be charged based on the number of targeting options they select. For example, an advertiser may be charged $1000 CPM for two targeting options and $1500 CPM for four targeting options. In addition, various “targeting package” may be offered that provide pre-defined “levels” of targeting.

Any of the above targeting schemes may be implemented using matching logic, key words, etc, as described in more detail below, and with respect to commonly owned PCT Patent Application No. ______ (attorney docket no. 573218002WO), filed Mar. 8, 2005, entitled “Matching and Scoring of Advertisements for Targeted Delivery into Multiple Video Games, Such as Single and Multiplayer Games.”

The insertion order 600 may also include information related to a buying scheme 618 for advertisements (e.g., network, hybrid, fixed, sponsorship, multi-media, etc.) and a related description 620. Specific timing requirements 622 may also be provided. Pricing information 626 may also be included on the insertion order 600. Implementation of many of the features of the insertion order 600 are described in the following sections.

Table A below, shows an example of campaign and targeting options that may be provided to advertisers and possibly presented as options on insertion orders.

TABLE A

| Campaign and Targeting options: | Example: |
|---|---|
| Run campaign for specific date range: from date A | Campaign begins October 15, advertisements |
| to date B | begin running in Network, campaign ends |
| | November 1, advertisements are pulled from |
| | Network |
| Run campaign during specific time of day only (can | Advertisements run during prime time only |
| pick hours or day part, e.g., prime time, late night, | |
| morning, daytime). Can also exclude certain days | |
| and times. | |
| Run campaign on specific day(s) of week only | Advertisements run on Thursday nights and |
| | during weekends only |
| Frequency cap: set limit on number of times a player | Advertiser sets frequency cap at 6x, player will see |
| sees the campaign within a single game session | advertisement no more than 6x during a single |
| | game session |
| Targeting and/or exclusions based on keywords | Advertisements run across network in all games |
| | except titles with World War II or German content |
| Targeting and/or exclusions based on Entertainment | Advertisements run across network in all games |
| Software Rating Board (ESRB) ratings, which are | except AO (adults only) and EC (Early |
| designed to provide information about video and | Childhood) rated titles |
| computer game content | |
| Targeting and/or exclusions by: | 1. Advertisements run in sports games only (or in |
| 1. Genre and sub-genre | all genres except sports) |
| 2. Title | 2. Advertisements run in Splinter Cell only (or in |
| 3. SKU | all titles except Splinter Cell) |
| 4. Zone | 3. Advertisements run in Splinter Cell, Japanese |
| 5. Inventory element | SKU only (or in all Splinter Cell SKUs except |
| | Japanese SKU) |
| | 4. Advertisements run only in zone 2 of particular |
| | title or all titles |
| | 5. Advertisement runs only on front of movie |
| | theatre in Mall Tycoon |
| Targeting by game context (as defined by standard | McDonald's advertisements run only on store |
| advertisement unit types, e.g., sign, structure, logo, | fronts (standard advertisement unit type is |
| and/or packaging). | structure). |
| Rotation options e.g.,: | Advertisement creative will remain static during |
| Static: Advertisement stays static as long as the user | length of single game session (e.g., a McDonald's |
| is playing the game, per session. | store front does not switch to a Citibank in the |
| Zone Static: Advertisement stays static as long as | middle of game play). |
| the user is in the zone, per session. | |
| Line of Sight Static: Advertisement stays static as | |
| long as the advertisement is in view, per session. | |
| After leaving view, the advertisement can change. | |
| Rotate Anytime: Advertisement can change | |
| anytime. | |
| Type of buy: | 1. Dynamic advertisement (e.g., Blockbuster |
| 1. Network (Advertisements run across all or a | video that changes) |
| subset of appropriate available ad units at that time, space | 2. Both a network and fixed advertisement (e.g., |
| on network) | Blockbuster store with an advertisement of a video |
| 2. Hybrid (Dynamic advertisements run within | that changes) |
| hard-coded advertisement placement) | 3. Product placement that is embedded within the |
| 3. Fixed (Hard-coded or unchanging | game (e.g., Blockbuster store) |
| advertisement) | |
| Targeting and/or exclusions based on geo-targeting | Advertisements target only those in NY and |
| (Country/Region/Cities or DMA) | Alpena, MI |
| Advertiser/Brand Separation | Only one advertiser from a category will be served |
| | into a single game session at one time |
| Targeting and/or exclusions based on player | Advertisements target men in Midwest, between |
| attributes (e.g., gender, age, zip code, geographic) | ages 22 and 28. |
| Interstitial airing between levels/during loading | Advertisement runs in segments between levels of |
| periods | a sport game. |
| Sponsorship (Advertiser sponsors a level of play, | Every available ad unit in a level of a game |
| scoreboard, etc.) | contains an ad from single advertiser's ad |
| | campaign |
| Multi-media (Advertisements run within a | Television screen in adventure game shows a |
| television, movie screen or other media | video advertisement; radio in game plays an audio |
| advertisement unit) | advertisement |
| Interactive (Advertisements bring in aspects of real | Player enters product bar code into advertisement |
| world - e.g., drink a soda and enter in code from | to achieve extra powers in an action/adventure |
| bottle cap to receive special powers) | game. |
| Mini Game (Advertisement is a game that is played | Between levels in a game, the player has the |
| within the game, such as in between sessions) | option of playing a mini branded game, which is |
| | fun and allows user to move to different levels or |
| | achieve extra powers in the game. |
| Live Data Feed (Live data is presented in the game) | E.g., stock ticker scrolls, weather outside affects |
| | weather in the game, sports scores displayed in |
| | game, etc. |

As provided in Table A above, certain advertisers may choose to opt in/out of games in the network based on key words provided with a game title or description, or used within the game itself. For example, an advertiser may wish to opt out of games containing the keyword “World War 2” (a keyword associated with a specific game title). Alternatively, a computer manufacturer may use the keyword “computer” if it wants its advertisements to be shown only on computer screens within games on the network. Examples of keywords that an advertiser may use to target or exclude (e.g., opt in/opt out) include the following: Car, Clothing, Computer, Cosmetics, Family planning, Germany, Home/garden, Hunting, Japan, Kiosk, Korea, Middle East, Retail, Sex, Terrorism, Toys, Travel, World War 2, blood, etc. This list provides only examples of keywords. In some cases, advertisers, publishers, and/or developers may select their own keywords for use, which may be automatically implemented into the system. In addition to “opting in” or “out” of keywords, advertisers may “opt in” or “opt out” based on ESRB ratings, genres, day part(s) and day of week. Some examples of genres include the following:
Action/Adventure—These games typically involve a mission that the player must achieve or a crime they must solve. Puzzles, clues, and an element of mystery all promote the player's mission. The player typically acts as the main character in the story with a high level of interaction with the game environment. The games can also include a high level of running, jumping, flying, etc. A well-known character acts as the action hero.
Fighting/Shooter—The player(s) fight or shoot their opponents and enemies in order to survive and win the game. They are fast-paced games requiring quick reflexes and little strategy.
Puzzle—Puzzle games are one of the oldest game genres and are usually played on PCs. The player must solve puzzles or navigate mazes.
Racing—Racing games place the player within a vehicle (car, boat, bike, etc.) and require the driver to compete against other drivers or against the clock. They provide good product type advertisement opportunities (e.g., car brands, motor oil, tires, etc.).
Role Playing/Fantasy—Role playing games place the player into a fantasy or science fiction environment. Player(s) usually adopt a character who possesses certain skills or abilities. These games are often played with multiple players.
Simulation—Simulation games have action, combat, and management, and are strategic. They simulate a specific activity and try to be as realistic and practical as possible. As well as providing general advertising opportunities, simulation games may provide many opportunities for advertisements that allow interaction with the physical world. In addition, simulation games may be directed toward specific demographic groups that are not targeted through other game types. For example, games like Mall Tycoon may target a demographic of teenage girls, which is not common in other game types.
Sports—Sports games include such professional sports as baseball, football, skateboarding, snowboarding, golf, basketball, tennis, and bowling. Sports games provide targeting opportunities for specific demographics (e.g., males 18-30). They may also be suitable for displaying sports-specific product advertisements. They are also often organized into tournaments that call for advertiser sponsorship.
Strategy—Strategy games usually attract a more mature audience, as they require a high level of thinking, planning and strategizing in order to advance. Often, the player(s) have control over a team who will enact commands given by the player(s). Strategy games are good candidates for targeting mature audiences, and also provide many opportunities for advertisements that allow interaction with the physical world.

In some embodiments, tournaments may be organized where multiple players gather to play a game (and compete against each other) during a given time frame. In such cases, it is possible to provide rankings during tournament play that can be displayed to all players in combination with advertisements. The advertising management service could, for example, advertise for a given tournament, and then have a single sponsor for that tournament. As an example, the advertising management service could run advertisements in Splinter Cell for a week or two that indicate that a tournament will occur next Thursday from 9 to 10 ET. In some embodiments, rather than embedded in the game, the tournament advertisements could include popup advertisements and/or advertisements that appear on a pause or score screen during tournament play. In addition, it is possible to have an advertiser “sponsor” such a tournament, so that the advertiser receives exclusive advertising rights during the tournament (e.g., advertise in each of the available ad units), thereby producing a significant impact on tournament players. Awards (such as performance coupons) may be provided to tournament winners in various categories (e.g., highest score, highest score per level, etc.).

In addition to selecting options for targeting, the insertion order may provide options for the advertiser to specify measurement and tracking options for its advertisement campaigns. Table B, below, shows an example of campaign and targeting options that may be provided to advertisers.

TABLE B

| Measurement and/or tracking option: | Example: |
|---|---|
| Unique player sessions: | Unique player sessions (cumulative): 1,506,134 |
| Total number of unique users reached by campaign | |
| (e.g., measured daily, cumulatively, or for specific | |
| time period) | |
| Effective Frequency: | Effective frequency of 6.7 |
| Number of times audience saw advertisement (15- | |
| second impression during single game session) | |
| Total reach: | Total reach (cumulative): 10,091,098 |
| Total number of time advertisements aired | |
| (measured daily, cumulatively, or for specific time | |
| period) | |
| Campaign Viewership: | 49% of campaign was seen during prime time (or |
| By Time of Day | 4,944,638 advertisements) and 34% (or |
| By Day of Week | 3,430,973 advertisements) were viewed during |
| By Genre | late night. 22% of campaign was seen on |
| | weekdays, the remainder during weekends. |
| Thresholds: | |
| All advertisements are tracked for total time on | |
| screen, size and rotation or angle of presentation to | |
| viewer. | |
| Advertisements reach or exceed set thresholds for a | |
| cumulative of N seconds in order to be ‘counted’ as an | |
| impression. | |

### B. Available Ad Units

In some embodiments, advertisement opportunities may be offered to advertisers based on standardized available ad units, which may include, for example signs (e.g., a billboard, poster, or other form of static sign regardless of its location), structure (e.g., an image mapped onto a building , such as a branded fast food storefront (McDonald's, Dunkin' Donuts, Baskin Robbins, Dominos Pizza), retail store (Gap, Target, Foot Locker, Blockbuster) , a bank (Citibank, Chase), or other location (movie theatre, etc.)), logos (e.g., a logo placed on clothing worn by game characters (T-shirts, hats, sports gear) or on objects interacted within the game context (logo on car, on skateboard, on computer monitor, or on a cell phone used by character) or other smaller environments where branding is more appropriate), packaging (e.g., packaging for products within the game such as cans, wrappers, bags, etc. (for example, a pizza box, vending machine, etc.)), and menus/loading pages (e.g., an image that appears on the loading page of a game (the loading page is the screen that appears while the gamer waits for a game to load in the console or PC or on any menu pages in the game, such as at the start of a game)).

The use of standardized available ad units facilitates the sale of advertising that spans across multiple games/titles because one advertisement can fit into many available ad units of a standard advertisement unit type. In addition, advertisers can simultaneously reach large audiences without creating multiple versions of the media. Also, advertisers can easily deliver media that will not be stretched or skewed when shown in the game, allowing them to protect their image while also keeping the games' solid appearance.

In addition to the standardized available ad units described above, other types of available ad unit types may be implemented in the advertisement delivery scheme and associated facility. For example, it may be possible to include ad units that allow for adding certain live content into the game, such as live sports scores, weather, video clips or webcam feeds, and so forth. It may also be possible to include content that is unrelated to advertising, such as holiday decorations to buildings in game scenery, or other changes to the game play to enhance the user's experience.

In some embodiments, because player information may be stored, it is possible to include ad units that allow for in game performance coupons/prizes that would go to, for example, player of the day, best player of a given game, best player at a given level, beating a high score, and so forth.

In some embodiments, ad units may allow for tying real world advertising into the game. For example, a soft drink top could include a code—an indication to the purchaser that the code can be entered into Level 3 of the given game to provide a special benefit (e.g., entering the code into Level 3 of Splinter Cell allows the player to get a special gun). In another example, an actual energy bar could allow for extra energy in a game by entering an appropriate code on the wrapper. In this way, a physical product is tied to a related ability in the game.

In some embodiments, an ad unit may be configured as an “Adver Game,” such as a mini game that is effectively an advertisement. For example, a mini game may involve blatant branding and at times trivial game play. Such mini games could be between levels, and could actually have levels of their own, so that later levels are more difficult than earlier ones. Each of these mini games may be associated with one or more specific products, thereby performing an advertising function.

In some embodiments, the advertisement management service system may send bots or electronic agents into the game as advertising units or real characters in the game, which advertise or promote a product (e.g., a game character may move around a screen holding a can of Pepsi and ask player if they would like a drink).

In some embodiments, beyond sound and motion, the advertisement management service may provide available ad units that allow advertising at the beginning and end of a game and in between game levels (similar to commercials). For example, a movie trailer runs at the beginning of all games currently being played in association with the advertisement management service on Thursday night before a corresponding movie release on Friday. In another example, a 15-second Domino's commercial may run at 8 p.m. in all games played in association with the advertisement management service during the break when the gamer moves from one level to the next.

### C. Billing

Once advertisers have provided their campaign specifications, the advertisement management service may manage billing the advertisers using one or more billing schemes. In some embodiments, billing may occur at setup and/or after “flight” has occurred (i.e., the advertisements have actually been displayed in games). For example, advertisers may be charged a set-up fee once the insertion order has been signed, regardless of flight start date. The set-up fee may be processed at the same time invoicing occurs (e.g., the first Thursday following the end of the broadcast month). In some embodiments, a share of the collected set-up fee may be disbursed to the publisher upfront, or at the time the advertiser's flight has ended. For example, a share of the collected set-up fee may be disbursed to the publisher upfront, regularly during the flight, or at the time the advertiser's flight has ended.

In addition to set-up fees, advertisers may also be subject to broadcast fees that correlate to actual impressions or other factors, at least a portion of which may also ultimately be paid to publishers. For example, to set up a broadcast invoice, a report may be generated and used to create invoices for all advertisers that ran for the broadcast month based. As an example, fees may be charged based on Impressions Delivered×CPM (cost per 1000 impressions) over a past 30-day period. From these fees, payables to each publisher may be determined based on revenue share. For example, a financial report for each title may be sent to the publisher of that title with a check. In some embodiments, this financial report may include one or more of the following: a list of advertisers that were in flight for the period that ran in the individual title, total served impressions into the title, previous outstanding balance (due from advertisers), total payments received for previous periods, new impressions billed for period (based on the current invoices sent to advertisers), no charge impressions, total payments on set-up fees, outstanding current balance (due from advertisers), etc.

### IV. Impression Counting and Tracking

In some embodiments, an advertisement presented in a game is considered an “impression” if it is viewed by a game player and if its presence on the screen meets certain specified parameters (e.g., time viewed, angle of presentation, and size of presentation relative to screen size). For example, when an image (or other media) is presented to a game player during game play, impression data may be collected by each game application (e.g., using client library functionality) and uploaded into an impression database controlled by an impression database at the advertisement management system. The impression information may then be aggregated into online reports for advertisers and publishers. In some embodiments, after upload, the impression server may record data from the game to determine whether certain thresholds are met and whether an impression can be recorded.

As described above, whether an impression is recorded depends on satisfaction of one or more thresholds. In some embodiments, a size threshold may relate to the on-screen size of the advertisement image as it appears to the gamer. For example, an advertisement image may need to meet a specified minimum percentage of screen area to be counted as an impression. The minimum percentage specified may vary based on the type of advertisement unit. Likewise, an angle threshold may refer to the angle between the game player and the direction the advertisement image is facing. For example, the angle may need to meet a specified angle (e.g., 45 degrees) to be counted as an impression. This prevents very oblique appearances from being counted as impressions.

Advertisement presentations that meet angle and size thresholds may also need to meet time thresholds before they can be counted as impressions. Accordingly, in some embodiments, minimum time refers to the minimum time duration that the advertisement presentation must meet or exceed when presented to a player in order to count as an impression. An example of an application of all three threshold levels is as follows: A player drives a car down a road and sees a billboard sign. While the billboard sign is in view for several seconds, only three of those seconds may meet size and angle thresholds. Accordingly, if the time threshold is greater than three seconds, an impression will not be recorded in this case.

In some embodiments, the advertisement delivery scheme and associated facility may track the length of time an image appears on screen even if it does not constitute an impression and aggregate the total time the gamer has been exposed to the image (e.g., 15 seconds cumulative), thereby implementing the idea that multiple insufficient views can “add up” to an impression. For example, if a player drives a car around a racetrack several times and each time sees a billboard for three seconds at the threshold angle and size, after five laps the cumulative impressions viewed by the gamer equals fifteen seconds (3 seconds×5 laps). In this case, one impression cycle is counted, and the advertisement server is reset to start recording the next impression cycle. In another example, a Jumbotron in a sports arena is periodically rotating through several advertisements (each from a different campaign). Advertisement A meets the size/angle impression recording thresholds for five seconds, Advertisement B for three seconds, and Advertisement C for ten seconds. As the advertisements are rotated, an impression is counted: for Advertisement A after three rotations (5 seconds×3 rotations); for Advertisement B after five rotations (3 seconds×5 rotations); and for Advertisement C after 1.5 rotations (10 seconds×1.5 rotations).

In general, the above approach does not measure an impression when it is delivered into the game. Instead, unlike the typical network ad server approach (which determines impressions before presentation), the impression is tracked and reported after it has been on the viewer's screen at or above a minimum size and angle, and a minimum duration of time (cumulative). This provides an accurate and fair way to track impressions, as it is based on actual presentation factors instead of predicted presentation factors. Besides the time/angle/size thresholds described above, other information may be used to qualify impressions. For example, occlusions, relative volume (in the case of audio) brightness, clarity, etc., may be used as factors in determining whether one or more presentations of an advertisement qualify as an impression. In addition to counting impressions, the impression server may also record data relating to views that did not count as impressions (e.g., if a presented advertisement was in view but did not meet the size/angle/time thresholds).

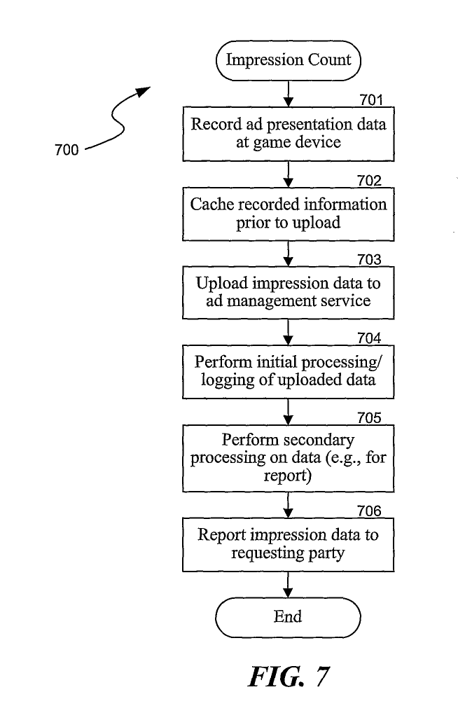

Referring back to FIGS. 3 and 4, a routine associated with impression counting may take place at multiple aspects of the advertising delivery scheme and associated facility. For example, the routine may begin at the advertisement recipient client (via the client library functionality), proceed to the advertisement management service system, and then conclude at one or more advertiser systems (via reporting mechanisms provided to advertisers). FIG. 7 provides a high-level flow diagram showing a routine 700 for impression counting.

At block 701, the routine 700 records information about what the game application is actually presenting to a game player, which typically occurs at the advertisement recipient client. At block 702, the routine 700 caches the recorded information until an upload connection is established with the advertisement management service system. More particularly, the routine 700, via the game application, may track each game frame (e.g., frame at T1, T2, T3, etc.) to determine the angle and size at that particular game frame. Particular events may be recorded (e.g., each time a frame has a threshold-related change). Accordingly, some preprocessing of the tracked information may occur at the game application. At block 703, the routine 700 uploads the cached impression data (events) to the advertisement management service system (e.g., the impression server). At block 704, routine 700 performs initial processing and logging of the uploaded impression data. At block 705, the routine performs secondary processing (e.g., aggregation and analysis) of the logged impression data. At block 706, the routine 700 reports the aggregated impression data to a recipient (e.g., the publisher system, advertiser system, etc.).

In some embodiments, the advertisement delivery scheme and associated facility may track whether “unused” available ad units satisfy impression thresholds. Aside from impression data, other types of game play data may be collected using the techniques described above (or similar techniques), as is described in more detail below with respect to reporting.

### V. Reporting

The advertising delivery scheme and associated facility may provide a variety of reports at many different levels. This may include reports about impressions and campaigns, as well as information on how many people are playing, what game levels are reached, which objects (e.g., cars, weapons, scenes) players are selecting in games, etc. For example, a REPORT IMPRESSIONS function may used to record statistics regarding the “visibility” of advertisements from the gamer player's perspective within the game. These statistics are passed to the function, and are dependent on the type of advertisement media being viewed (image, audio, video, etc.). In another example, reports may include information about what times of day people are playing a particular game. In yet another example, reports may include information about which weapons or game paths players of an action/adventure game are selecting.

In some embodiments, the REPORT IMPRESSIONS function analyzes the reporting data passed to it, against cached data regarding impression thresholds. If the passed-in statistics meet or exceed the impression thresholds, an impression record is cached within the library. If the statistics do not meet or exceed the impression threshold, a view record is cached. The cached impression and view thresholds may be flushed (manually or automatically) periodically.

In some embodiments, a detailed reporting component provides functionality to perform detailed reporting regarding, for example, campaigns, flights, title performance, etc. Examples include demographics delivery information, served data versus impression data, and a variety of other highly detailed reports based on extreme low granularity advertisement.

In some embodiments, publisher reporting components consist of reports that track the performance of a publisher's Title/SKU library or specific Title/SKU, including number of players, length played, number of advertisements served, and revenue generated. An example of such a report 800 is shown in FIG. 8. As shown, the information in the report 800 may include an insertion order ID selection box 802, an insertion order ID number 804, a client identifier 806, a campaign identifier 808, a date range identifier 810, a demographics information section 812, an impressions booked field 814, an impressions served field 816, and an impressions average duration field 816.

In some embodiments, the data collected by the advertisement delivery scheme and associated facility may include other information besides impression data. For example, it may include the number of players that play particular games over a given time period, times of day that players play, days of the week that players play, the geographic locations of players, average time played, average level played, number of times an advertisement has met or been below threshold, and so forth. From this, the advertisement management service can determine various criteria, such as number of gamers that did not get to a given level or how long it took them to get to a given level, and other type of game progress information. The information collected may be of varying detail. For example, information may be collected that shows no players use a particular weapon in a given game or that players of certain games also like other games (e.g., those who like driving games also like certain simulation games). This data can be particularly valuable to game designers who need feedback on game play and may be sold to developers, publishers, and other parties.

### VI. Conclusion

In general, unless the context clearly requires otherwise, throughout the description, the words “comprise,” “comprising,” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in this Detailed Description using the singular or plural number may also include the plural or singular number respectively. The word “or” in reference to a list of two or more items, that word covers all of the following interpretations of the word: any of the items in the list, all of the items in the list, and any combination of the items in the list.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified. Each of these processes or blocks may be implemented in a variety of different ways. Also, while processes or blocks are at times shown as being performed in series, these processes or blocks may instead be performed in parallel, or may be performed at different times.

Aspects of the invention may be stored or distributed on computer-readable media, including magnetically or optically readable computer discs, hard-wired or preprogrammed chips (e.g., EEPROM semiconductor chips), nanotechnology memory, biological memory, or other data storage media. Indeed, computer-implemented instructions, data structures, screen displays, and other data under aspects of the invention may be distributed over the Internet or over other networks (including wireless networks), on a propagated signal on a propagation medium (e.g., an electromagnetic wave(s), a sound wave, etc.) over a period of time, or they may be provided on any analog or digital network (packet switched, circuit switched, or other scheme). Those skilled in the relevant art will recognize that portions of the invention reside on a server computer, while corresponding portions reside on a client computer such as a console, PC, or portable device, and thus, while certain hardware platforms are described herein, aspects of the invention are equally applicable to nodes on a network.

The teachings of the invention provided herein can be applied to other systems, not necessarily the system described herein. The elements and acts of the various embodiments described above can be combined to provide further embodiments.

Any patents, applications, or other references noted herein, including any that may be listed in accompanying filing papers, are incorporated herein by reference. Aspects of the invention can be modified, if necessary, to employ the systems, functions, and concepts of the various references described above to provide yet further embodiments of the invention.

These and other changes can be made to the invention in light of this Detailed Description. While the above description details certain embodiments of the invention and describes the best mode contemplated, no matter how detailed the above appears in text, the invention can be practiced in many ways. Details may vary considerably in its implementation details, while still being encompassed by the invention disclosed herein. For example, advertisements, or other data such as audio or video, may be streamed to the game console or computer using existing data streaming technology. In another example, available ad units can be grouped so that if an advertisement appears in one of the elements of the group, corresponding advertisements appear in the other elements. The corresponding advertisements can be the same advertisements or a set of advertisements. This is a variation on the exclusive category in that the process of choosing an advertisement for the first element proceeds as usual, but once an advertisement is chosen for one element in the group, then the advertisement choices of the remaining available ad units in the group may conform to the group rules. This is not to be confused with sequential delivery of a related set of advertisements. The advertisements in a group appear simultaneously (and are delivered together). There is no implied ordering. In yet another example, concepts of the invention are applied to non-gaming environments (including educational environments, recreational environments, etc.).

As noted above, particular terminology used when describing certain features or aspects of the invention should not be taken to imply that the terminology is being redefined herein to be restricted to any specific characteristics features, or aspects of the invention with which that terminology is associated. In general, the terms used in the following claims should not be construed to limit the invention to the specific embodiments disclosed in the specification, unless the Detailed Description explicitly defines such terms. Accordingly, the actual scope of the invention encompasses not only the disclosed embodiments, but also all equivalent ways of practicing or implementing the invention.

Some of the components described herein include representative computer displays or web pages. The screens may be implemented in C++ or as web pages under XML (Extensible Markup Language), HTML (HyperText Markup Language) or any other scripts or methods of creating displayable data, such as the Wireless Access Protocol (“WAP”). Indeed much of the system may be implemented in XML, or alternatively in binary form to speed transmission and processing. The screens or web pages provide facilities to receive input data, such as game play. However, screens or web pages may of course also provide a form with fields to be filled in, pull-down menus or entries allowing one or more of several options to be selected, buttons, sliders, hypertext links or other known user interface tools for receiving user input. While certain ways of displaying information to users is shown and described, those skilled in the relevant art will recognize that various other alternatives may be employed. The terms “screen,” “web page” and “page” are generally used interchangeably herein.

When implemented as web pages, the screens are stored as display descriptions, graphical user interfaces, or other methods of depicting information on a computer screen (e.g., commands, links, fonts, colors, layout, sizes and relative positions, and the like), where the layout and information or content to be displayed on the page is stored in a database. In general, a “link” refers to any resource locator identifying a resource on a network, such as a display description provided by an organization having a site or node on the network. A “display description,” as generally used herein, refers to any method of automatically displaying information on a computer screen in any of the above-noted formats, as well as other formats, such as email or character/code-based formats, algorithm-based formats (e.g., vector generated), or matrix or bit-mapped formats. While aspects of the invention are described herein using a networked environment, some or all features may be implemented within a single-computer environment.

We claim:

1. A system for playing computer or video games and displaying advertising to an audience playing the computer or video games, the system comprising:
multiple electronic game platforms, wherein each game platform includes:
a display screen;
an input device;
a network connection;
memory at least temporarily storing game elements under multiple computer or video games, and storing an advertising presentation process; and
a data processor coupled to the display screen, input device, network connection, and memory, wherein the processor is programmed:
to execute elements of the computer or video game as a player plays the computer or video game, wherein the computer or video game includes multiple advertising locations to receive advertisements,
to receive advertisements via the network connection under direction of the advertising presentation process,
to insert advertisements into the advertising locations under direction of the advertising presentation process, and,
to provide reporting data regarding impressions of the advertisements provided to the player under direction of the advertising presentation process; and
a game advertising system for broadcasting multiple advertisements associated with advertisement campaigns across multiple games to the multiple electronic game platforms, wherein at least some of the broadcasted advertisements are matched to at least some of the multiple games based on establishing a correspondence between a genre or category associated with the broadcasted advertisements and a genre or category assigned to the multiple games, and wherein the game advertising system includes:
an advertising database containing the multiple advertisements, wherein at least one advertisement is associated with each of the advertisement campaigns;
an advertising location database identifying multiple advertising locations within each of the multiple games; and,
an advertising server in communication with the advertising and advertising location databases and at least at times in network communication with the multiple electronic game platforms;
wherein the advertising server is programmed:
to provide the least one advertisement associated with each of the advertisement campaigns to the advertising presentation process of the multiple electronic game platforms via the network connection, and
to count the delivery of each of the advertisements based on the reporting data received.

2. The system of claim 1 wherein the advertisements include audiovisual advertisements and animation advertisements, wherein the data processor is also configured to insert advertisements into the advertising locations under direction of the advertising presentation process when the electronic game platform is not connected to a network, and,
wherein the multiple games include a first set of games sharing a first common game classification, and a second set of games sharing a second, different game classification, and wherein each advertising campaign can designate or exclude: the first or second game play classification, a time parameter, a geographic parameter, or a player parameter.

3. The system of claim 1 wherein the advertising server is programmed to count impressions of advertisements based on a size of an advertising image displayed, a view angle of the advertising image, a visibility duration of the advertising image, and a percent occlusion of the advertising image.

4. A method for delivering advertisements within a computer or video game or games running on a player's computer or game console, the method comprising:
providing an update request to a remote server;
downloading data with respect to new advertising media associated with multiple inventory elements associated with the game or games, wherein the inventory elements represent locations within the game or games where at least one of the advertising media may be displayed or replayed to the player via the computer or game console, and wherein the new advertising media is selected for the game or games based on at least one genre or type classification associated with the game or games;
during a session of game play, displaying or replaying to the player via the computer or game console at least some of the advertising media with respect to the multiple inventory elements; and
uploading reporting data associated with the displaying or replaying to the player of the advertising media.

5. The method of claim 4, further comprising:
uploading parameters with respect to the game or games;
receiving client authentication from the remote server; and,
setting default media for default displaying or replaying to the player with respect to at least some of the inventory elements.

6. The method of claim 4 wherein the update request occurs in relation to a zone change within the game, and wherein the downloading data with respect to new advertising media includes downloading pointers to memory locations storing the advertising media.

7. The method of claim 4 wherein the advertising media includes advertising images, wherein an impression of any one of the advertising images is considered as being viewed to the player only if the one advertising image is displayed to the user and meets time viewed and other parameters or other parameter thresholds, and wherein another impression of the one advertising image cannot be counted until the one advertising image has been not displayed for a minimum length of time.

8. The method of claim 4, further comprising:
intermittently and automatically connecting to the remote server; and,
periodically pulling new advertising data and/or advertising media from the remote server and passing the new advertising media to the game or games to be displayed in appropriate inventory elements.

9. A system for displaying ads in electronic games, wherein the electronic games are played on computers, game consoles, or both, which are coupled to a network, the system comprising:
an ad server configured to exchange data with the computers or game consoles via the network, wherein the ad server includes:
a game development module, wherein the game development module is configured to specify inventory elements in electronic games for ad placement, and to provide a display of details of inventory elements;
a game advertisement module, wherein the game advertisement module is configured to receive ads and provide the received ads to the computers or game consoles for display or replay within inventory elements of the electronic games, wherein for at least one of the received ads and for at least one of the electronic games, providing the received ad is based, at least in part, on matching a classification associated with the electronic game with a classification or target specified by an advertiser associated with the received ad; and
a game publishing module, wherein the game publishing module is configured to provide a display of reporting data with respect to ads presented within the inventory elements of the electronic games.

10. The system of claim 9 wherein the details of inventory elements includes, for each inventory element of a particular electronic game, at least two of the following: a name, a description of the inventory element with respect to the particular electronic game, an image size, and a bit depth.

11. The system of claim 9 wherein each of the requests to insert ads includes at least two of the following: a client name, an ad campaign name, an ad media, a campaign time frame, a target number of impressions, a game zone or zones, and an inventory element or elements.

12. The system of claim 9 wherein the impression report includes at least two of the following: a client name, a campaign name, a date range, male/female demographics, computer/game console demographics, impressions served, and average impression duration.

13. The system of claim 9 wherein the game publishing module is configured to permit electronic game publishers to approve or reject requests to insert ads into their electronic individual games.

14. The system of claim 9 wherein the details of inventory elements includes, for each inventory element of a particular electronic game, an identifier and at least one parameter related to a kind of, or format for, an advertisement acceptable for that inventory element.

15. An apparatus for providing ads in electronic games, wherein the electronic games are played on multiple computers, game consoles, or both, which are coupled to a network, the apparatus comprising:
advertising server means for serving ads to inventory elements within electronic games played on the multiple computers or game consoles, wherein for at least one of the ads and for at least one of the electronic games, serving the ad is based, at least in part, on matching a classification associated with the electronic game with a classification selection specified by an advertiser associated with the ad;
media server means for providing, via the network, electronic advertising media to the multiple computers or game consoles; and
impression server means for receiving, via the network, ad presentation data from the multiple computers or game consoles and determining which ads delivered during play of the electronic games count as impressions.

16. The apparatus of claim 15 wherein the impression server means includes means for receiving time data, game location data, game identifying data, and data regarding a visibility or audibility of electronic advertising.

17. The apparatus of claim 15 wherein the advertising media includes at least two different advertising images associated with a common advertising campaign, and wherein the impression server means includes means for receiving presentation data associated with amounts of time each of the two advertising images were viewable during electronic game play, and for adding the amounts of time to overcome a time threshold and count as an impression.

18. The apparatus of claim 15 wherein the advertising server means includes means for providing data associated with advertising for each new zone of electronic games.

19. The apparatus of claim 15 wherein the advertising server means includes means for defining a set of characteristics for inventory elements.

20. A method for delivering advertisements within computer or video games, the method comprising:
receiving an ad campaign request to place an ad within computer or video games, without specifying a specific computer or video game title; and
broadcasting at least one electronic ad associated with the advertising campaign for substantially simultaneous display in multiple, different computer or video games, wherein for at least one of the ads and for at least one of the electronic games, the broadcasting is based, at least in part, on matching a classification associated with the electronic game with a target classification specified by an advertiser associated with the ad.

21. The method of claim 20 wherein the broadcasting includes providing a uniform resource locator (“URL”) to a memory location on a remote server that stores the at least one electronic ad.

22. The method of claim 20 wherein the advertising campaign is based on at least one time criterion, geographic criterion, or audience demographic.

23. The method of claim 20 wherein the one electronic ad associated with the advertising campaign is displayed differently in the multiple computer or video games depending upon a type of advertising location within the multiple computer or video games.

24. The method of claim 20 wherein the one electronic ad is presented before or after the multiple computer or video games start or end, respectively, between discrete game play zones, or during a pause screen within the multiple computer or video games.

25. The method of claim 20, further comprising:
receiving ad presentation data that includes ad viewing time;
accumulating the ad viewing time to achieve cumulative lengths of view time that exceed a threshold, and
counting an ad if a cumulative length of view time exceeds the threshold.

26. The method of claim 20, further comprising:
receiving revenue from an advertiser for an ad campaign based on a total number of ad impressions provided by the multiple computer or video games;
retaining a portion of the revenue and generating a revenue remainder; and
providing at least a portion of the remainder to multiple game publishers or game developers based on a pro rata portion each of the multiple computer or video games provided to the total ad impressions.

27. The method of claim 20 wherein the advertising campaign is based on at least one time game criterion exclusion, or advertising category exclusive, across multiple computer or video games.

28. The method of claim 20 wherein the ad comprises a mini game that can be played at the beginning of the multiple computer or video games, at the end of the multiple computer or video games, in between levels of the multiple computer or video games, or any combination thereof.

29. The method of claim 20 wherein the ad includes an input feature, and wherein the input feature allows game players to enter product codes to provide a game playing advantage and/or enhanced experience in the multiple computer or video games.

30. The method of claim 20 wherein the broadcasting is conducted in association with a scheduled game playing tournament, and wherein the advertisement campaign is associated with a sponsor of the game playing tournament.

31. An method for displaying or replaying advertisements in electronic games played, wherein the electronic games are played on multiple gaming devices, the method comprising:
receiving advertisement campaign information, wherein the advertisement campaign information includes data for presenting at least one advertisement and data for automatically targeting sub-channels associated with the electronic games; and
receiving information regarding available advertisement units associated with at least some of the electronic games, wherein the available advertisement unit information includes information to allow targeting of advertisements to the sub-channels, including targeting by game genre; and
dynamically and automatically serving the at least one advertisement to available advertisement units within all of the electronic games played on the multiple gaming devices, or within a targeted sub-channel of electronic games played on the multiple gaming devices.

32. The method of claim 31 wherein the dynamically serving the at least one advertisement includes serving a group of related advertisements to a grouped set of available advertising units.

33. The method of claim 31 further comprising collecting information about presentation of the dynamically served advertisement.

34. The method of claim 31 further comprising tracking information about game playing, wherein the information about the game playing includes one or more of: information about a number of players that play the electronic games over a given time period, information about times of day that players play the electronic games, information about days of the week that players play the electronic games, information about average game play times, information about game levels or game elements that receive high amounts of play, or information about game levels or game elements that receive low amounts of play.

35. A method for delivering advertisements within electronic games, the method comprising:
aggregating locations for advertisements from an aggregation of multiple, different electronic games; and
defining a subset of advertisement locations from the aggregated advertisement locations for delivery of advertisements to the subset of advertisement locations, wherein the subset of advertisement locations targets a game playing audience having a common characteristic.

36. The method of claim 35 wherein the common characteristic is age, gender, playing habits, geographic location, or purchasing habits.

37. A computer-readable medium containing a data structure associated with tracking presentation of an electronic advertisement delivered via a network connection comprising:
first information element identifying the advertisement delivered via the network connection, wherein the advertisement is selected for delivery to at least one electronic game based, at least in part, on matching a genre or topic associated with the at least one electronic game with a genre or topic specified by an advertiser associated with the advertisement; and
second information element providing a count of a number of times the advertisement was presented during play of the at least one electronic game.

38. The computer-readable medium of claim 37 wherein at least the second information element is collected based on feedback data gathered while the advertisement is presented during network play of the electronic game,
wherein the feedback data includes time data associated with multiple time segments in which the advertisement was presented, presentation data associated with an angle of presentation or relative size of presentation for each of the time segments in which the advertisement was presented, and visibility data associated with an amount of occlusion associated with presentation of the advertisement; and
wherein the time, presentation, and occlusion data is employed to determine whether a quality of presentation of the advertisement was satisfactory enough to be included in the number of times the advertisement was presented.

39. The computer-readable medium of claim 37, further comprising third information element associated with demographics of players playing the electronic game.

40. The computer-readable medium of claim 37 wherein the computer-readable medium is a memory of an impression counting component at an advertisement delivery facility.

41. The computer-readable medium of claim 37 wherein the second information element is associated with aggregating information from multiple sequential or non-sequential time segments of presenting the advertisement during play of the electronic game.

42. The computer-readable medium of claim 37 wherein the second information element is associated with determining a quality of presenting the advertisement during play of the electronic game before incrementing the number of times the advertisement was presented.

43. The computer-readable medium of claim 37 wherein the computer-readable medium is a logical node in a computer network receiving the contents.

44. The computer-readable medium of claim 37 wherein the computer-readable medium is a computer-readable disk or tape.

45. The computer-readable medium of claim 37 wherein the computer-readable medium is a data transmission medium carrying a generated data signal containing the contents.

46. The method of claim 4, further comprising inserting into the inventory elements advertisements locally stored in the computer or game console when the computer or game console is in an off-line mode.

47. The method of claim 31, further comprising designating or excluding, for each advertising campaign, a game play classification, a time parameter, a geographic parameter, or a player parameter.

48. A method of providing information from a computer or video game running on a player's computer or game console, the method comprising:
identifying multiple electronic elements within the computer or video game, where at least some of the multiple electronic game elements may be displayed or replayed to a player via the computer or game console;
during a session of game play, tracking a player's interaction with at least some of the identified electronic game elements; and,
uploading reporting data to a remote server, wherein the reporting data is associated with the tracking of the player's interaction with the at least some of the identified electronic game elements.

49. The method of claim 48, further comprising providing to a developer of the computer or video game, in exchange for compensation, a report regarding the reporting data, and wherein the computer or game console forms one of multiple the computer or game consoles all coupled via a network and all uploading reporting data.

50. The method of claim 49 wherein the computer or game console is a mobile device.

51. The method of claim 9 further comprising:
an administrative module providing an interface for controlling and configuring the ad server.
